(19) United States
(12) Patent Application Publication
(10) Pub. No.: US 2007/0015452 A1
(43) Pub. Date: Jan. 18, 2007

(54) Air guiding apparatus for wind power generation

(76) Inventor: Shih H Chen, Yongkang City (TW)

Correspondence Address: HDSL, 4331 STEVENS BATTLE LANE, FAIRFAX, VA, 22033, US

(21) Appl. No.: 11/428,820

(22) Filed: Jul. 5, 2006

(30) Foreign Application Priority Data
Jul. 7, 2005 (TW) 094211517

(51) Int. Cl. B60S 1/54

(52) U.S. Cl. 454/121

(57) ABSTRACT

An air guiding apparatus includes a duct, a guiding unit, and a turbine. The duct defines a through-hole therein to form an inside wall. The duct includes an inlet, and an outlet. The guiding unit is mounted to the inside wall of the duct and located in the through-hole of the duct to divide the through-hole of the duct into an expanding part at the inlet of the duct, and a narrow flow channel connecting the inlet and the outlet of the duct. The turbine is mounted to the duct and located in the flow channel.

### BACKGROUND OF THE INVENTION

The present invention relates to an air guiding apparatus, and particularly to an air guiding apparatus for wind power generation.

An additional wind power generating device is disclosed in Taiwan Patent No. M250048. The wind power generating device includes a base, a duct vertically mounted to the base. The duct defines a space therein. A plurality of clapboards is formed in the space of the duct. A plurality of faveolate compartments is formed. Each compartment includes an inlet for guiding the wind in, and an outlet for guiding the wind out. A windy wheel is mounted in each compartment. Each windy wheel includes a nave, and a plurality of windy leaf blades extending out from a circumference of the nave. The wind coming from the inlet of each compartment pushes the windy leaf blades of the corresponding windy wheel to rotate. The wind energy is converted into mechanical energy. A power generating unit is connected to the windy wheels to receive the mechanical energy. Thus, the power generating unit can generate power.

The above-mentioned wind power generating device can generate power source via a plurality of windy wheels connecting with the power generating unit. However, inner walls of each compartment are plane board. Rotating speeds of each windy wheel are easily dependant on wind's speeds. The compartments cannot compress the wind to a high pressure when the wind's speed is lower. Consequently, rotating speeds of the windy wheels are easily unstable.

What is needed is to provide an air guiding apparatus for efficiently generating power.

### SUMMARY

An exemplary air guiding apparatus includes a duct, a guiding unit, and a turbine. The duct defines a through-hole therein to form an inside wall. The duct includes an inlet, and an outlet. The guiding unit is mounted to the inside wall of the duct and located in the through-hole of the duct to divide the through-hole of the duct into an expanding part at the inlet of the duct, and a narrow flow channel connecting the inlet and the outlet of the duct. The turbine is mounted to the duct and located in the flow channel.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an isometric view of an air guiding apparatus in accordance with a preferred embodiment of the present invention, together with a windy wheel mounted thereto;

FIG. 2 is an exploded, isometric view of FIG. 1, but viewed from another aspect;

FIG. 3 a cutaway view of FIG. 1, showing the windy wheel in working;

FIG. 4 is a front view of FIG. 1, showing the windy wheel in working;

FIG. 5 is an exploded, isometric view of an air guiding apparatus in accordance with a second embodiment of the present invention, together with a windy wheel mounted thereto; and

FIG. 6 is assembled view of a plurality of air guiding apparatuses and windy wheels of FIG. 5.

### DETAILED DESCRIPTION OF THE INVENTION

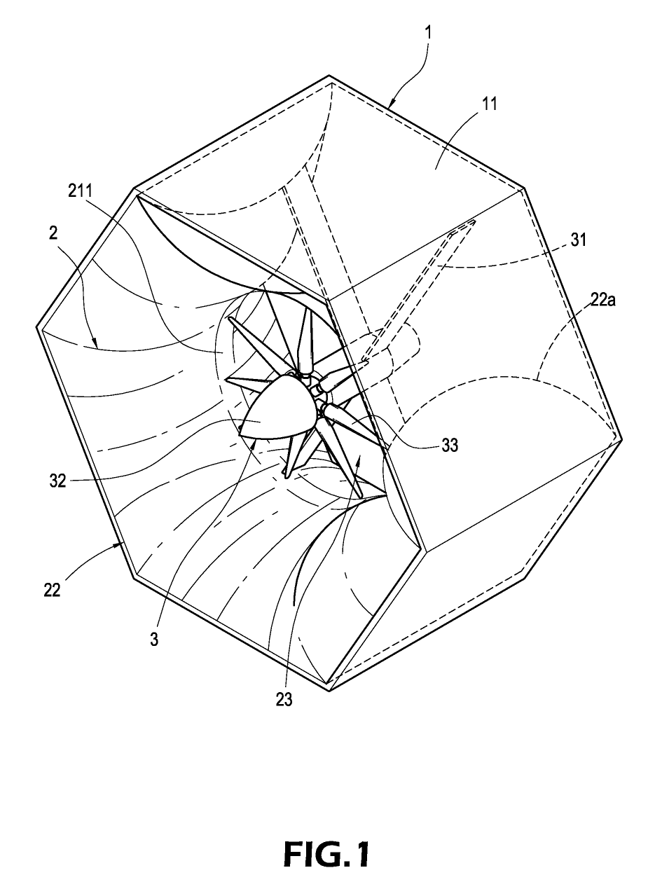

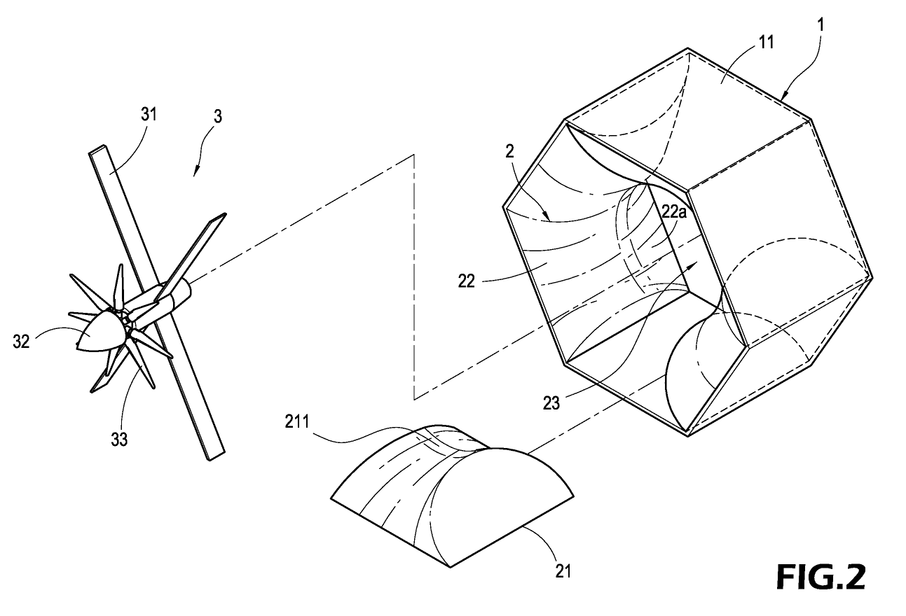

Referring to FIGS. 1 and 2, an air guiding apparatus in accordance with a preferred embodiment of the present invention includes a duct 1, a guiding unit 2, and a turbine 3.

The duct 1 having a polygon includes a plurality of boards 11 Every two adjacent boards 11 are connected with each other via jointing, pin joint, and etc. The duct 1 can also be bent from a plate. A through-hole is defined in the duct 1 among the boards 11.

The guiding unit 2 is made of light weight materials, such as expandable material, etc. The guiding unit 2 mounted to inside walls of the duct 1. The guiding unit 2 includes a plurality of guiding members 21. Each guiding member 21 corresponds to a board 11 and includes a cambered surface 211 located in through-hole and opposite to the corresponding board 11. Thus, the through-hole of the duct 1 is divided into three parts. The three parts include two expanding parts 22, 22a at opposite ends of the duct 1, and a narrow flow channel 23 connecting the expanding parts 22, 22a.

The turbine 3 is mounted to the duct 1 and located in the flow channel 23. The turbine 3 includes at least one bracket 31 connected to the inside walls of the duct 1, a nose cone 32 pivotably mounted to the bracket 31, and a plurality of leaf blades 33 mounted to the nose cone 32.

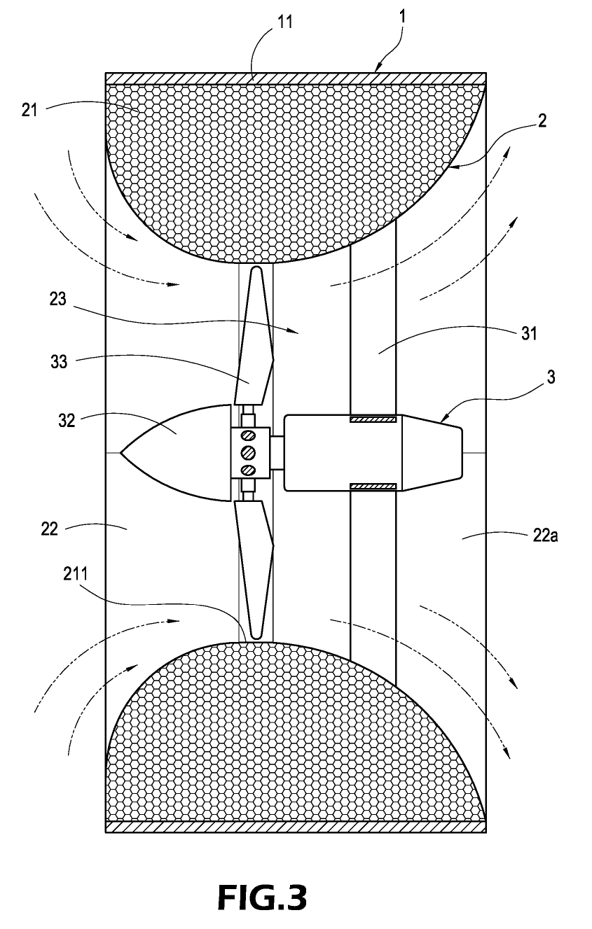

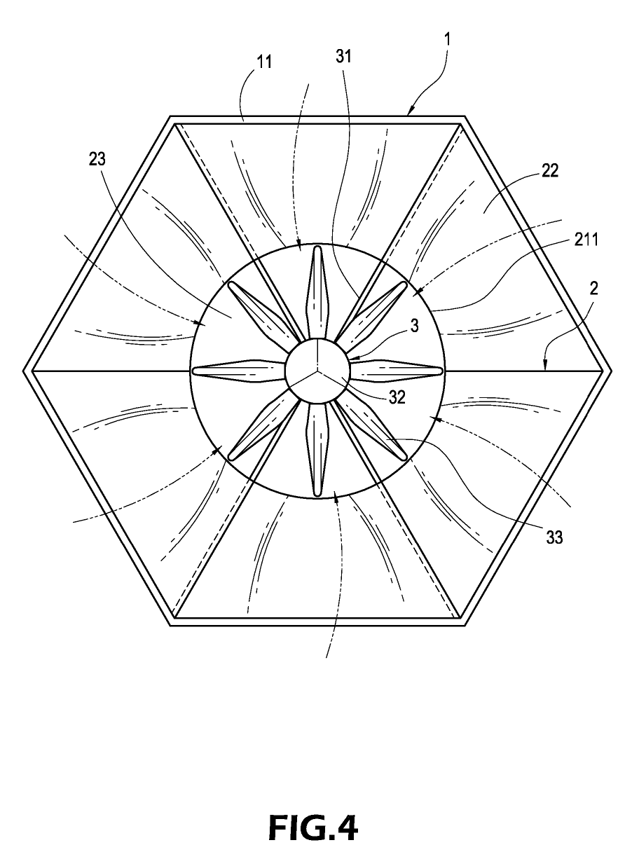

Referring also to FIGS. 3 and 4, in working, wind moves toward the guiding unit 2. The wind enters into the through-hole of the duct 1 through the expanding part 22. The wind is accelerated when passing through the narrow flow channel 23. A whirlpool at distal ends of the leaf blades 33 of the turbine 3 is reduced. The accelerated wind makes the turbine 3 to rotate faster. Then, the wind moves out through the expanding part 22a. A high efficiency is achieved. Noise produced by the leaf blades 33 rotating lowers.

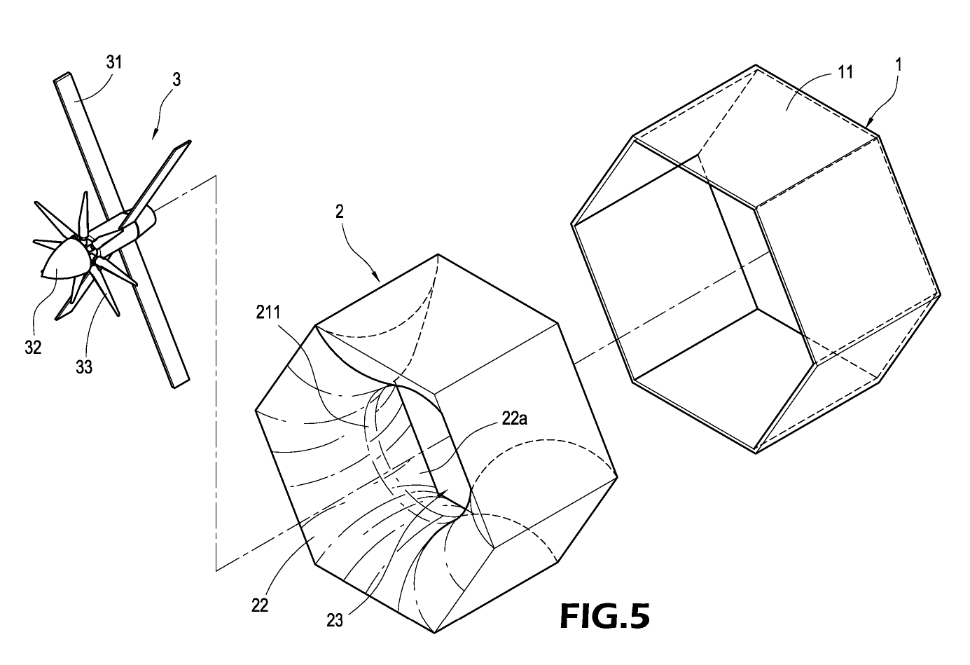

Referring also to FIG. 5, an air guiding apparatus in accordance with an alternative preferred embodiment of the present invention is shown. In this embodiment, the guiding unit 2 is made from a single member.

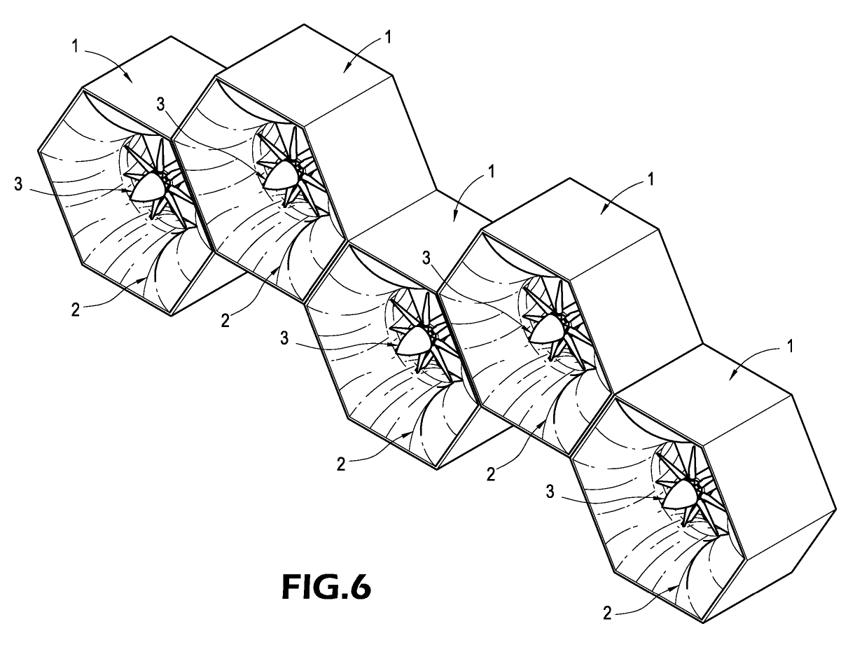

Referring also to FIG. 6, in working, a plurality of air guiding apparatus is mounted together to satisfy a need of large power energy.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

We claim:

1. An air guiding apparatus for wind power generation, comprising:
a duct including a through-hole therein to form an inside wall, an inlet, and an outlet; and
a guiding unit mounted to the inside wall of the duct and located in the through-hole of the duct to divide the through-hole of the duct into an expanding part at the inlet of the duct, and a narrow flow channel connecting the inlet and the outlet of the duct.

2. The air guiding apparatus as claimed in claim 1, wherein the duct comprises a plurality of boards, every two adjacent board are connected to each other via jointing or pin joint.

3. The air guiding apparatus as claimed in claim 1, wherein the duct is made from a plate.

4. The air guiding apparatus as claimed in claim 1, wherein the guiding unit comprises a plurality of guiding members, each guiding member comprises a cambered surface located in through-hole.

5. The air guiding apparatus as claimed in claim 1, wherein the guiding unit is made from a single member.

6. The air guiding apparatus as claimed in claim 1, wherein the guiding unit is made of light weight materials.

7. An air guiding apparatus for wind power generation, comprising:
a duct including a through-hole therein to form an inside wall, an inlet, and an outlet;
a guiding unit mounted to the inside wall of the duct and located in the through-hole of the duct to divide the through-hole of the duct into an expanding part at the inlet of the duct, and a narrow flow channel connecting the inlet and the outlet of the duct; and
a turbine mounted to the duct and located in the flow channel.

8. The air guiding apparatus as claimed in claim 7, wherein the duct comprises a plurality of boards, every two adjacent board are connected to each other via jointing or pin joint.

9. The air guiding apparatus as claimed in claim 7, wherein the duct is made from a plate.

10. The air guiding apparatus as claimed in claim 7, wherein the guiding unit comprises a plurality of guiding members, each guiding member comprises a cambered surface located in through-hole.

11. The air guiding apparatus as claimed in claim 7, wherein the guiding unit is made from a single member.

12. The air guiding apparatus as claimed in claim 7, wherein the guiding unit is made of light weight materials.

13. The air guiding apparatus as claimed in claim 7, wherein the turbine comprises a bracket mounted to the inside wall of the duct, a nose cone pivotably mounted to the bracket, and a plurality of leaf blades mounted to the nose cone.
